(19) United States
(12) Patent Application Publication
(10) Pub. No.: US 2016/0185246 A1
(43) Pub. Date: Jun. 30, 2016

(54) CHARGING MANAGEMENT DEVICE, CHARGING MANAGEMENT SYSTEM, AND CHARGING MANAGEMENT METHOD

(71) Applicant: KABUSHIKI KAISHA TOSHIBA, Tokyo (JP)

(72) Inventor: Topon PAUL, Kawasaki (JP)

(73) Assignee: KABUSHIKI KAISHA TOSHIBA

(21) Appl. No.: 15/066,640

(22) Filed: Mar. 10, 2016

Related U.S. Application Data
(63) Continuation of application No. PCT/JP2014/074256, filed on Sep. 12, 2014.

(30) Foreign Application Priority Data
Sep. 20, 2013 (JP) 2013-195987

(51) Int. Cl. B60L 11/18

(52) U.S. Cl. CPC B60L 11/1844; B60L 11/1846; B60L 11/1861

(57) ABSTRACT

A charging management device has a first acquisition circuitry which acquires EV information necessary to charge each EV car in a charging station, a second acquisition circuitry which acquires stationary storage battery information, a third acquisition circuitry which acquires supply power information from a system power, a fourth acquisition circuitry which acquires charger information, a preliminary charging amount calculation circuitry which calculates a preliminary charging amount representing a charging amount of each EV car, an EV charging model storage circuitry which stores an EV charging model outputting a maximum charging amount of the EV car, and a charging condition determination circuitry which determines a charging condition that the charging time of each EV car and the maximum output power of the charger are within certain ranges, respectively, and the difference between the maximum charging amount of each EV car and the preliminary charging amount is further reduced.

### CROSS REFERENCE TO RELATED APPLICATIONS

This application is based upon and claims the benefit of priority from the prior Japanese Application No. 2013-195987, filed on Sep. 20, 2013, the entire contents of which are incorporated herein by reference.

### FIELD

Embodiments of the present invention relates to a charging management device, charging management system, charging management method which performs charging management of an electric vehicle.

### BACKGROUND

At the time of charging an electric vehicle (hereinafter, referred to as an EV car), since a request charging power varies with a residual amount of a battery, charging demands of the EV cars in an individual charging station are changed. Since a change in power consumed in the charging station adversely affects stabilization of a power system, there is a need to balance the charging demands by adjusting the output of a charger based on the available power.

On the other hand, since it takes longer time to charge an EV car, there is a possibility that the charging waiting time of the EV car at the charging station may be long. Since the increase in charging waiting time adversely affects the traffic condition in the periphery of the charging station as well as the drivers, the charging waiting time needs to be reduced, if possible.

In case of simultaneously charging a plurality of EV cars or storage batteries, there is a known method of creating a charging power pattern such that the contract power is not exceeded and charging the EV cars based on the pattern. However, since a request charging power varies with the residual amount of a battery or a storage battery of each EV car, there is a problem in which a charging load exerted on the power system fluctuates.

Although the peak of power demand can be shifted by using a stationary storage battery, if the charging amount of each EV car and the charging power are not adjusted, there is a problem that the charging waiting time will be longer or the charging load exceeds the contract power. In addition, if the charging amount to each EV car is reduced in order to shorten the charging waiting time, there is a problem in which the charging of the EV car will be frequently requested, and running out of energy en route may happen.

### BRIEF DESCRIPTION OF THE DRAWINGS

FIG. 1 is a block diagram illustrating a schematic configuration of a charging management device 1 according to a first embodiment;

FIG. 2 is a flowchart illustrating schematic process operations of a charging condition determination unit 8;

FIG. 3 is a diagram illustrating an example of a table representing an EV charging model;

FIG. 4 is a diagram illustrating another example of a table representing an EV charging model;

FIG. 5 is a flowchart illustrating detailed process operations of the charging condition determination unit 8;

FIG. 6 is a diagram illustrating an example of a method of determining the maximum output power CPm of a charger, the maximum charging amount Emax, and the maximum charging time CTm of an EV car;

FIG. 7 is a diagram illustrating charging amount adjustment performed by a charging amount adjustment unit 9;

FIG. 8 is a diagram illustrating an example of EV charging information and charging service information outputted by the charging information output unit 10;

FIG. 9 is a diagram illustrating an example of previous charging data;

FIG. 10 is a diagram illustrating an example of charging reservation data;

FIG. 11 is a diagram illustrating an example of OD data of the number of EV cars;

FIG. 12 is a block diagram illustrating a schematic configuration of a charging management device 1 according to a second embodiment;

FIG. 13 is a flowchart illustrating process operations of a charging condition determination unit 8 according to the second embodiment;

FIG. 14 is a block diagram illustrating a schematic configuration of the charging management device 1 where a preliminary charging calculation unit is omitted;

FIG. 15 is a diagram illustrating a table representing an example of a stationary storage battery discharging model;

FIG. 16 is a block diagram illustrating a schematic configuration of a charging management system 23 including a plurality of charging stations 21 and an upper-level EMS 22;

FIG. 17 is a flowchart illustrating process operations of an upper-level EMS 22 according to a fourth embodiment;

FIGS. 18A and 18B are diagrams illustrating a method of determining a plurality of charging stations 21 and a charging amount;

FIG. 19 is a flowchart illustrating an example of determining a plurality of charging stations 21 and a charging amount by using a genetic algorithm; and

FIGS. 20A, 20B, and 20C are diagrams illustrating a procedure of processes of FIG. 19.

### DETAILED DESCRIPTION

A charging management device according to one embodiment has a first acquisition circuitry which acquires EV information necessary to charge each EV car in a charging station, a second acquisition circuitry which acquires stationary storage battery information including a maximum output power of a stationary storage battery provided in the charging station, a third acquisition circuitry which acquires supply power information from a system power which can be used to charge each EV car in the charging station, a fourth acquisition circuitry which acquires charger information including a maximum output power of a charger provided in the charging station, a preliminary charging amount calculation circuitry which calculates a preliminary charging amount representing a charging amount of each EV car which can be charged in the charging station based on the information acquired by the first to fourth acquisition circuitries, an EV charging model storage circuitry which stores an EV charging model outputting a maximum charging amount of the EV car by using the maximum output power of the charger and the charging time of the EV car as input parameters, and a charging condition determination circuitry which, after a certain constraint condition is satisfied, determines a charging condition that the charging time of each EV car and the maximum output power of the charger are within certain ranges, respectively, and a difference between the maximum charging amount of each EV car and the preliminary charging amount is further reduced.

Hereinafter, embodiments of the present invention will be described with reference to the drawings.

### First Embodiment

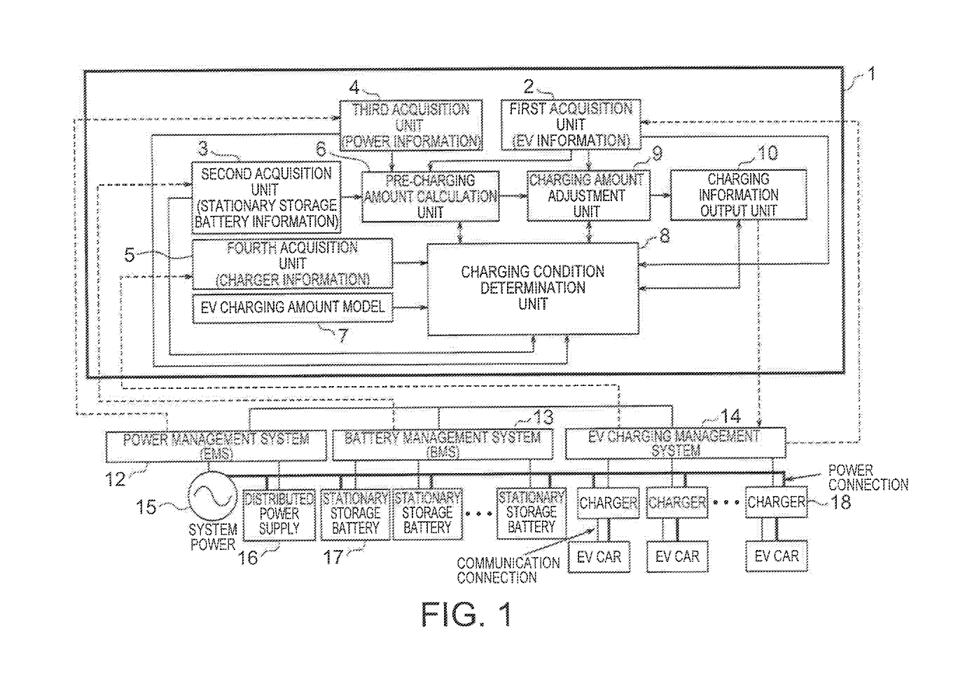

FIG. 1 is a block diagram illustrating a schematic configuration of a charging management device 1 according to a first embodiment. The charging management device 1 of FIG. 1 determines the maximum charging amount which can be supplied to each EV car waiting for charging, the maximum charging power (=the maximum power of a charger), and the maximum charging time by taking into consideration the number of EV cars arriving within a time period of Interest. In the embodiment, this determination reduces a charging waiting time of each EV car and balances charging loads of the EV car exerted on a system power by effectively using a stationary storage battery. Herein, the EV car denotes all kinds of vehicles having two or more wheels which are driven by a motor using a battery as a power source.

The charging management device 1 of FIG. 1 is installed, for example, in a charging station. Alternatively, in a case where the charging management device 1 can transmit/receive various types of information to/from the charging station through a communication network, the installation site of the charging management device 1 is not particularly limited.

The charging management device 1 of FIG. 1 is connected to a power management system 12, a battery management system 13, and an EV charging management system 14. A system power system 15 and a distributed power supply 16 are connected to the power management system 12. The power management system 12 stores related information of the system power system 15 and the distributed power supply 16 of the charging station. While recognizing and predicting power supply and demand of the charging station, the power management system controls the power of the system power system 15 and the power of the distributed power supply 16 based on the power supply and demand of the charging station. At least one stationary storage battery 17 is connected to the battery management system 13, and the battery management system 13 manages charging and discharging of the stationary storage battery 17. At least one charger 18 is connected to the EV charging management system 14. The EV charging management system 14 stores information on the charger 18 and EV car-associated information. The EV charging management system controls a charging output power of the charger 18 according to a request from the charging management device 1 and manages charging of each EV car.

The charging management device 1 of FIG. 1 is configured to include a first acquisition unit (first acquisition circuitry) 2, a second acquisition unit (second acquisition circuitry) 3, a third acquisition unit (third acquisition circuitry) 4, a fourth acquisition unit (fourth acquisition circuitry) 5, a preliminary charging amount calculation unit (preliminary charging amount calculation circuitry) 6, an EV charging amount model storage 7, a charging condition determination unit (charging condition determination circuitry) 8, a charging amount adjustment unit (charging amount adjustment circuitry) 9, and a charging information output unit (charging information output circuitry) 10.

The first acquisition unit 2 acquires EV information necessary for charging each EV car in a charging station. More specifically, the first acquisition unit 2 acquires the EV information corresponding to charging, waiting-for-charging, and scheduled-to-arrive EV cars in the charging station. If a new EV car arrives in the charging station, the first acquisition unit 2 issues an EV charging re-planning event and notifies the charging time period of interest and the information on the charging, waiting-for-charging, and scheduled-to-arrive EV cars to the preliminary charging amount calculation unit 6.

In the case of a charging EV car, the EV information acquired by the first acquisition unit 2 includes at least one of the remaining time until charging completion and the remaining supply charging amount information. In the case of a waiting-for-charging EV car, the EV information includes at least one of the number of EV cars, the battery residual amount (in the case of being capable of being acquired), and the EV type. In the case of the scheduled-to-arrive EV car, the EV information is the number of EV cars or the like. In the case of the scheduled-to-arrive EV car, the EV information is calculated by using, previous charging history data, charging reservation data, or statistical OD (origin-destination) data. The charging time period of interest may be set to next one hour, or charging demand peak time, or a predetermined specific time (for example, 8 hours).

The second acquisition unit 3 acquires the stationary storage battery information including the maximum output power of the stationary storage battery 17 provided in the charging station. The stationary storage battery information includes a stationary storage battery residual amount and specification information, for example, a maximum discharging power, a maximum charging power, the upper and lower limit values of the residual amount, or the like.

The third acquisition unit 4 acquires the supply power information from the system power which can be used for charging each EV car in the charging station. The supply power information includes supply power information for the next T hours from the current time, for example, the time-series data of the maximum supply power and the unit price (yen/kWh) of the electricity, or the like. The supply power information may include the supply power information from the system, the distributed power supply information, for example, the power-generation estimation information of the distributed power supply, unit price of distributed power, dynamic pricing of, and demand response (DR) planning, or the like.

The fourth acquisition unit 5 acquires charger information including the maximum output power of the charger 18 provided in the charging station. More specifically, the fourth acquisition unit 5 acquires charger information including the number of chargers installed in the charging station, status of use, and the maximum output power. Besides, the charger information may include specification information of the charger 18, for example, a maximum output power, a maximum output current, a maximum output voltage, a maximum charging time, and the like.

The preliminary charging amount calculation unit 6 calculates the preliminary charging amount representing a charging amount of each EV car which can be charged in the charging station based on the information acquired by the first to fourth acquisition units 2 to 5.

The EV charging amount model storage 7 stores information about the EV charging amount model that outputs the maximum charging amount of an EV car by using the maximum output power of the charger 18 and the charging time of the EV car as input parameters.

After a certain constraint condition is satisfied, the charging condition determination unit 8 changes the charging time of each EV car and the maximum output power of the charger in various ways within certain ranges to determine a charging condition so that the difference between the maximum charging amount of each EV car and the preliminary charging amount becomes smaller. The charging condition determination unit 8 supplies the determined information to the charging information output unit 10. In addition, if the above-described information is determined, the charging condition determination unit 8 issues an adjustment event to the charging amount adjustment unit 9. Herein, a certain range can be defined, for example, in advance.

The charging amount adjustment unit 9 receives the adjustment event and adjusts the maximum charging amount of each EV car determined by the charging condition determination unit 8. More specifically, if the battery residual amount of each EV car can be acquired, the charging amount adjustment unit 9 acquires the battery residual amount of the waiting-for-charging EV car from the first acquisition unit 2 and acquires the information of the maximum charging amount of each EV car from the charging information output unit 10. Next, the charging amount adjustment unit 9 adjusts the maximum charging amount of each EV car according to the battery residual amount of each waiting-for-charging EV car. Herein, the adjustment is performed, for example, so that the charging amount of each EV car is increased if possible. The charging amount adjustment unit 9 issues a re-determination event to the charging condition determination unit 8 so as to re-determine the maximum charging amount of each EV car and the maximum output power of the charger 18 according to the adjustment amount of the maximum charging amount. When the charging condition determination unit 8 receives the event, the charging condition determination unit re-determines the maximum charging amount of each EV car and the maximum power of the charger 18 and stores the information in the charging information output unit 10. If the charging amount adjustment unit 9 cannot acquire the battery residual amount of each EV car, the charging amount adjustment unit does not perform the adjustment process.

Next, the preliminary charging amount calculation method performed by the preliminary charging amount calculation unit 6 will be described. First, the preliminary charging amount calculation unit 6 calculates energy (unit is kWh) which is available within a time period T of interest using, for example, Formula (1).

$$Available Energy \text{:} E ( {t}_{c} ) = {\sum }_{t = {t}_{c}}^{T + {t}_{c}} {P}_{g} ( t ) \times s / 3600 + {E}_{SSB} ( {t}_{c} ) - {E}_{charging} ( {t}_{c} ) \qquad ( 1 )$$

Herein, tc is the current time, Pg (t) is the supply power (kW) from the system at the time t, s is the sampling interval (seconds), ESSB (tc) is a residual amount (kWh) of the stationary storage battery 17; and Echarging (tc) is a request energy (kWh) required to complete charging of the charging EV car.

Next, the preliminary charging amount calculation unit 6 calculates the total(N) of the number of waiting-for-charging EV cars and the number of scheduled-to-arrive EV cars and by using the total number of EV cars calculated before, calculates the average charging amount as the preliminary charging amount Ep that can be supplied to each EV car. In this case, the calculating formula is represented by Formula (2).

Preliminary Charging Amount Ep=E(tc)/N (2)

The preliminary charging amount calculation unit 6 may apply a weighting factor to each EV car and calculate the preliminary charging amount based on at least one of the battery residual amount of the waiting-for-charging EV car, the car type, and existence or non-existence of advance charging reservation. For example, the pre-charging amount calculation unit may calculate a ratio of the necessary charging amount necessary for traveling up to the next charging station and the battery residual amount at the current time and may apply the weighting factor according to the calculated ratio. Alternatively, the weighting factor of an EV car that makes advance charging reservation may be set to a higher value. Alternatively, the weighting factor of an emergency vehicle may be set to a higher value.

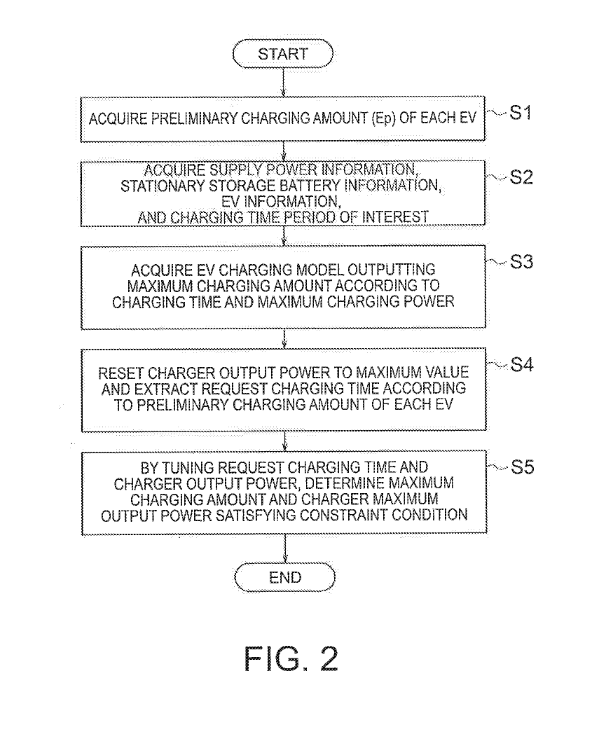

FIG. 2 is a flowchart illustrating schematic process operations of the charging condition determination unit 8. First, the preliminary charging amount Ep calculated by the preliminary charging calculation unit is acquired (step S1).

Next, the EV information, the stationary storage battery information, the supply power information, and the charger information are acquired by first acquisition unit 2, the second acquisition unit 3, the third acquisition unit 4, and the fourth acquisition unit 5, respectively (step S2). It is assumed that the EV information includes the charging time period of interest.

Next, the EV charging amount model that outputs the maximum charging amount by using the charging time and the maximum charging power as input parameters is acquired by the EV charging amount model storage 7 (step S3).

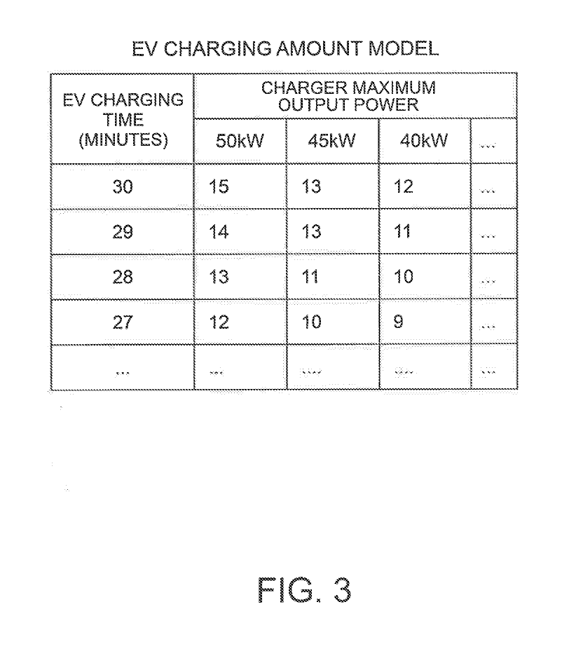

FIG. 3 is a diagram illustrating an example of a table (hereinafter, referred to as an EV charging model table) representing the EV charging amount model. The EV charging model table of FIG. 3 outputs the maximum charging amount (kWh) which can be supplied to the EV car by using the charging time (minutes) and the maximum output power (kW) of the charger 18 as input parameters.

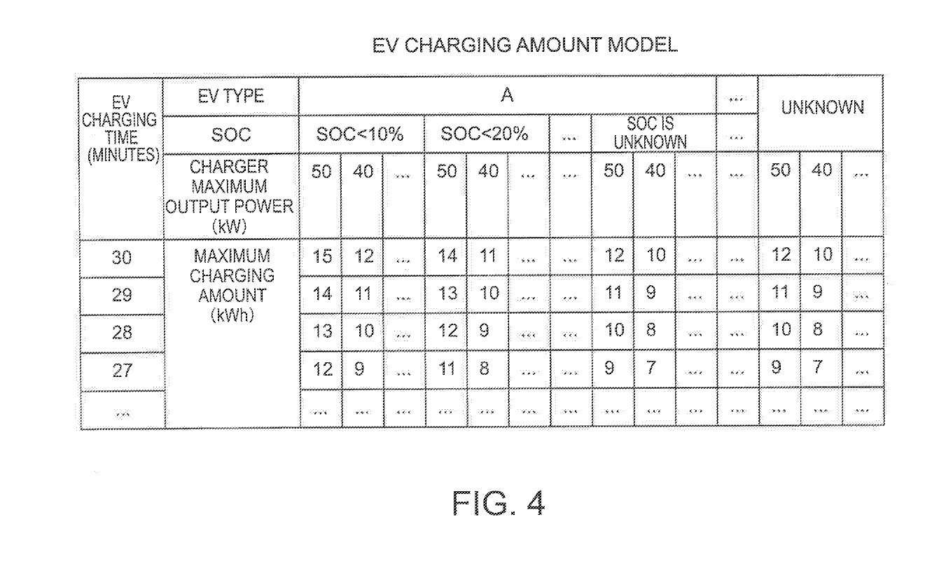

The EV charging model table of FIG. 3 is used for the case where the EV type and the battery residual amount of the EV car are unknown. On the other hand, in the case where the EV type and the state of charge (SOC) of the EV car are known, an EV charging model table, for example, illustrated in FIG. 4 is used. The EV charging model table of FIG. 4 outputs the maximum charging amount that can be supplied to each EV car by using the charging time, the EV type, the maximum output power (kW) of the charger 18, and the maximum charging amount of the EV car as input parameters. The EV type is a type of a battery mounted in an EV car, and in FIG. 4, the EV type is simply represented by “A”.

In FIGS. 3 and 4, the charging time may include the charging setup/operation time. Herein, the charging setup/operation time is, for example, the time necessary for connecting the EV car to the charger 18 and/or disconnecting it from the charger 18, the time taken to move the EV car from a parking lot to the charger 18 in order to perform charging, or the like.

Next, the output power of the charger 18 is set to the maximum value, and the request charging time is extracted according to the preliminary charging amount of each EV car (step S4). Finally, by tuning the request charging time and the output power of the charger 18, the maximum charging amount, the maximum charging time, and the charger maximum output power satisfying the constraint condition are determined (step S5).

The constraint condition is, for example, at least one of the following conditions 1 to 3. Alternatively, other constraint conditions may be employed.

1. Total Request Charging Time≦Charging Time Period of Interest

2. Request Discharging Power of Stationary Storage Battery≦Maximum Power of Stationary Storage Battery

3. Request Discharging Amount of Stationary Storage Battery≦Battery Residual Amount of Stationary Storage Battery

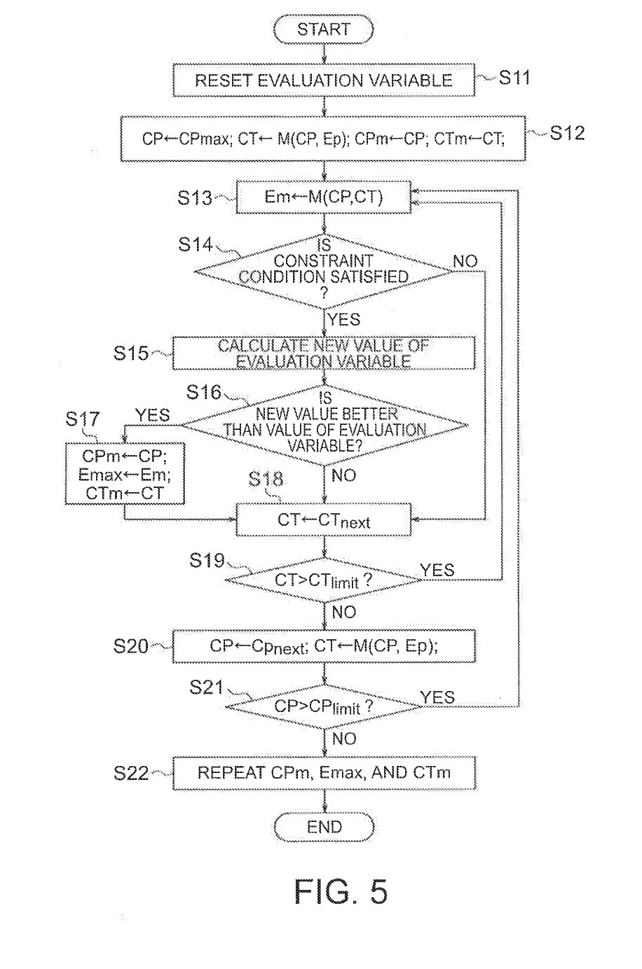

FIG. 5 is a flowchart Illustrating detailed process operations of the charging condition determination unit 8. First, an evaluation criterion is determined, and an evaluation variable is reset (step S11). The evaluation criterion is, for example, the maximum charging amount closest to the preliminary charging amount, the minimum charging waiting time, or both of the maximum charging amount closest to the preliminary charging amount and the minimum charging waiting time. When the maximum charging amount closest to the preliminary charging amount is used as an evaluation criterion, the maximum charging amount Emax and the maximum charging amount Em are reset as evaluation variables. Herein, Emax F←0 and Em←Ep are set. Herein, the Ep is the preliminary charging amount. When the minimum charging waiting time is used as an evaluation item, the minimum charging waiting time CWmin and the charging waiting time CW are reset as evaluation variables. For example, CWmin E←infinity are set. Herein, the infinity denotes a larger number. The charging waiting time CW is reset to the charging waiting time when the charging amount Em is supplied. The calculation of the charging waiting time is described later.

Next, the charging time variable CT, the maximum output power variable CP of the charger 18, the maximum output power CPm of the charger 18, and the maximum charging time CTm are reset (step S12). For example, the charger maximum output power variable CP is rest to the maximum value (for example, 50 kW) of the output of the charger of the EV charging model table.

At this time, the charging time of the EV car is calculated based on the maximum output power variable CP of the charger 18 and the preliminary charging amount Ep by employing the EV charging model table, and the calculated charging time is set to the charging time variable CT. This process is represented by CT←M (CP, Ep).

The charging time variable CT may be reset to the maximum value (for example, 30 minutes) of the charging time in the EV charging model M. In addition, the maximum output power CPm of the charger 18 is reset to the maximum output power variable CP, and the maximum charging time CTm is reset to the charging time variable CT.

Next, the maximum charging amount variable Em corresponding to the maximum output power variable CP and the charging time variable CT are outputted by using the EV charging model table (step S13). This process is represented by Em←M (CP, CT).

Next, it is checked whether or not a predetermined constraint condition is satisfied (step S14, first check unit). Herein, the constraint condition is, for example, at least one of the previously mentioned conditions 1 to 3. As a constraint condition, for example, average charging waiting time≦target charging waiting time may be added.

In a case where the constraint condition is satisfied, a new value of the above-mentioned evaluation variable used as an evaluation criterion is calculated (step S15). Next, it is checked whether or not the new value of the evaluation variable is better (step S16, second check unit). When the maximum charging amount closest to the preliminary charging amount is used as an evaluation criterion, it is checked whether or not the maximum charging amount Em is closer to the preliminary charging amount Ep than to the maximum charging amount Emax, that is, whether or not (Ep−Em)≦(Ep−Emax). When the minimum charging waiting time is used as an evaluation criterion, it is checked whether or not the charging waiting time CW is shorter than the minimum charging waiting time CWmin, that is, whether or not CW<CWmin. If the new value of the evaluation variable is not better, the charging time is updated (step S18). In this case, the process is represented by CT←CTnext. The CTnext is the next charging time of the EV charging model.

On the other hand, in a case where the new value of the evaluation variable is better, the evaluation variable is set to the new value of the evaluation variable, and the maximum output power (kW) of the charger 18, the maximum charging amount, and the maximum charging time are updated (step S17, parameter update unit). In this case, the process is represented by CPm←CP, Emax←Em, and CTm←CT.

When the process of step S17 is ended, the process of step S18 is performed. When the process of step S18 is ended, it is checked whether or not the charging time variable CT is larger than the lower limit value (step S19, third check unit). Namely, in step S19, it is checked whether or not the charging time of the EV car is within a predetermined range. In step S19, in a case where it is determined that the charging time variable CT is larger than the lower limit value, the processes after step S13 are repeated. In a case where the charging time variable CT is equal to or smaller than the lower limit value, the maximum output power variable CP of the charger 18 the charging time variable CT are updated (step S20). This process is represented by CP←CPnext and CT←M (CP, Ep). Herein, the CPnext is the next maximum output power of the charger 18 in the EV charging model table.

Next, it is checked whether or not the maximum output power variable CP of the charger 18 is larger than the lower limit value (step S21, fourth check unit). Namely, in step S21, it is checked whether or not the maximum output power (kW) of the charger 18 is within a predetermined range. In a case where it is determined in step S21 that the maximum output power is larger, the processes after step S13 are repeated. If not larger, at this time, the maximum output power CPm of the charger 18, the maximum charging amount Emax, and the maximum charging time CTm are outputted (step S22).

In flowchart of FIG. 5, when a feasible solution with respect to the maximum output power variable CP and the charging time variable CT is newly found, in step S17, the charger maximum output power CPm, the maximum charging amount Emax, and the maximum charging time CTm are updated. Namely, until the feasible solution is newly found, the values of the charger maximum output power CPm, the maximum charging amount Emax, and the maximum charging time CTm are retained.

Although the maximum output power variable CP is sequentially decreased down to the CPlimit until the feasible solution is found, the charger maximum output power CPm, the maximum charging amount Emax, the maximum charging time CTm are not changed.

For example, when the maximum charging amount closest to the preliminary charging amount is used as an evaluation item, in a case where the preliminary charging amount (Ep) is 8.0, the charger maximum output power variable CP is decreased in the order of 50, 45, 40, and 30, and the charging time is in a range of 30 minutes to 1 minute, the EV charging model table becomes a 4×30 matrix.

The value of the maximum output power variable CP is decreased in the order of 50, 45, 40, 30, and −1; the value of the CT is deceased in the order of 30, 29, 28, . . . , 1, and −1; the CPLimit is −1; and the CTlimit is −1. In the initial state, CP←50, CT←13, Emax←0, CPm←50, and CTm←13 are set.

A feasible solution 1 is set so that charger maximum output power=50, charging time=12 minutes, and charging amount=7.8. In addition, a feasible solution 2 is set so that charger maximum output power=45, charging time=15 minutes, and charging amount=7.6.

By 19 times of repetition of the checking process of step S19 of FIG. 5, the feasible solution 1 is found. At this time, maximum charging amount Em=7.8 and maximum output power variable CP=50 are obtained. Therefore, (Ep−Em)=0.2 and (Ep−Emax)=8.0−0=8.0 are obtained. In addition, in step S16, since (Ep−Em)≦(Ep−Emax), the process proceeds to step S17, so that CPm←50, Emax←7.8, and CTm←12 are obtained.

During the 20 to 46 times of repetition of the check process of step S19, since there is no feasible solution, the updates of the CPm, the Emax, and the CTm are not performed.

At the 47 times of repetition of the check process of step S19, the feasible solution 2 is found. At this time, the maximum charging amount Em=7.6 and the maximum output power variable CP=45. Therefore, (Ep−Em)=0.4 and (Ep−Emax)=8.0−7.8=0.2 are set. In step S16, (Ep−Em)>(Ep−Emax) is obtained, and the process of step S17 is not performed.

At the 125 times of repetition of the check process of step S19, in step S21, CP (=−1)≦CPlimit (=−1) is obtained, the process proceeds to step S22, so that 50 kW is selected as a charger maximum output power (CPm), 7.8 kWh is selected as a maximum charging amount (Emax), and 12 minutes is selected as a maximum charging time (CTm).

In addition, although the flowchart of FIG. 5 illustrates an example where the repetition process is performed until the charger maximum output power variable CP is smaller than the CPlimit, in step S17, at the time when the maximum output power of the charger 18, the maximum charging amount, and the maximum charging time are updated, the process of FIG. 5 may be ended. When the charging is performed in the charging station, the charging time taken up to the maximum charging amount varies with the battery residual amount of the EV car, both of the maximum charging amount and the maximum charging time are used as charging ending constraints. If not, there is a problem that, at the time of performing actual charging, the above-described constraint conditions may not be satisfied. For this reason, the charging condition determination unit 8 determines the maximum charging time as well as the maximum output power of the charger 18 and the maximum charging amount.

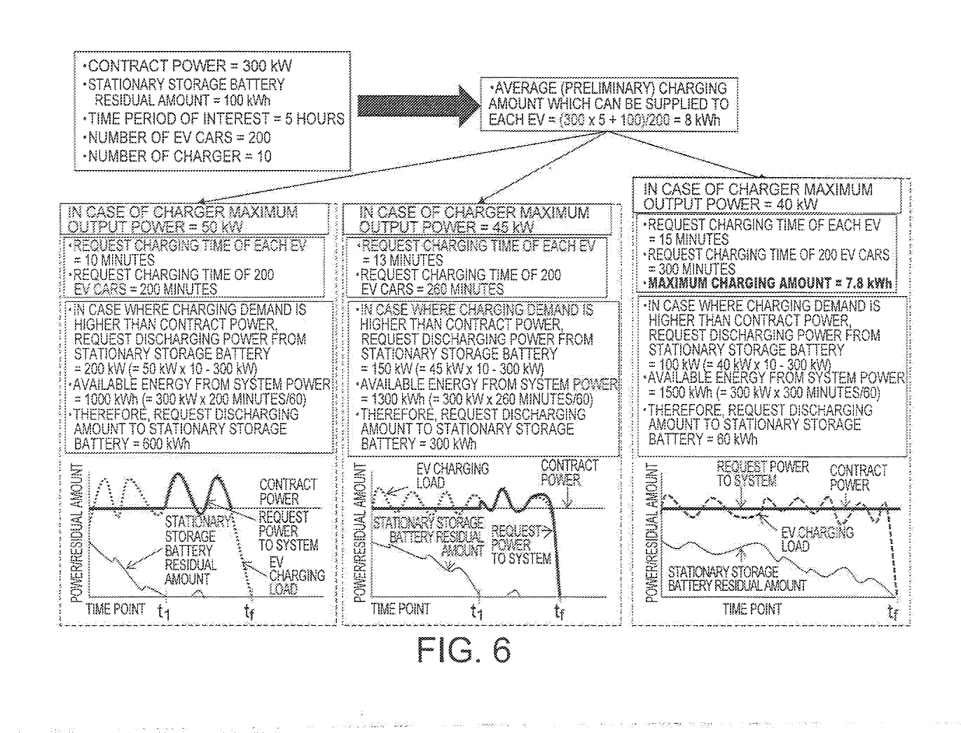

FIG. 6 is a diagram illustrating an example of a method of determining the maximum output power CPm of the charger 18, the maximum charging amount Emax and the maximum charging time CTm of the EV car. In FIG. 6, in a charging station, the contract power is set to 300 kW, the stationary storage battery residual amount is set to 100 kWh, and the number of chargers 18 is set to ten. The available maximum output power levels of the charger 18 are set to three types of 50 kW, 45 kW, and 40 kW.

In a case where it is desired to charge 200 EV cars within 5 hours, the preliminary charging amount calculated by the preliminary charging amount calculation unit 6 is (300×5+100)/200=8 kWh. In a case where the maximum output power of the charger 18 is 50 kW, the request charging time of each EV car is 10 minutes. In a case where the charging demand is higher than the contract power, since the request discharging power from the stationary storage battery 17 becomes 200 kW and the request discharging amount of the stationary storage battery 17 becomes 600 kWh (>stationary storage battery residual amount), if the charger maximum output power is set to 50 kW, the EV charging is not feasible.

In a case where the charger maximum output power is 45 kW, when the request charging time of each EV car is 13 minutes and the charging demand is higher than the contract power, since the request discharging power of the stationary storage battery 17 becomes 150 kW and the request discharging amount of the stationary storage battery 17 becomes 300 kWh (>stationary storage battery residual amount), if the charger maximum output power is set to 45 kW, the EV charging is not also feasible.

In this way, when the charger maximum output power is 50 kW or 45 kW, there is not feasible solution.

On the other hand, in a case where the charger maximum output power is 40 kW, when the charging amount is adjusted to be 7.8 kWh, the request charging time of each EV car is 15 minutes, and the charging demand is higher than the contract power, since the request discharging power from the stationary storage battery 17 becomes 100 kW and the request discharging amount of the stationary storage battery 17 becomes 60 kWh (≦stationary storage battery residual amount), if the charger maximum output power is set to 40 kW, the EV charging is feasible. Therefore, the charger maximum output power (CPm) becomes 40 kW, the maximum charging time (CTm) becomes 15 minutes, and the maximum charging amount (Emax) becomes 7.8 kWh.

Next, the process operations of the charging amount adjustment unit 9 will be described in detail. The charging amount adjustment unit 9 acquires the request charging amount information (Edi) of each EV car and performs adjustment of the supply charging amount (=preliminary charging amount, Ep) according to the request charging amount of each EV car. For this reason, the request charging amount can be set according to the needs. The charging amount adjustment unit 9 sets a larger request charging amount to a waiting-for-charging EV car having a higher priority. Herein, three examples of the setting of the request charging amount are exemplified. In a case where a user of the EV car can input a request charging amount value, the input value is used as a request charging amount. In a case where the user of the EV car cannot input the request charging amount value, residual amount of each waiting-for-charging EV car is acquired. The request charging amount is calculated by subtracting the residual amount from the upper limit charging amount of each waiting-for-charging EV car. As an example of the upper limit charging amount, there are 80% SOC (State Of Charge), full charging (=100% SOC), or 30-minute charging. The request charging amount may be set according to a scheduled travel distance. The request charging amount is represented by, for example, Formula (3).

Request Charging Amount Edi=min(Ecapi−Eri,Di×FEi) (3)

Herein, the Ecapi is the battery capacity (kWh) of a waiting-for-charging EVi or the upper limit charging amount of the EVi; the Eri is the battery residual amount (kWh) of the waiting-for-charging EVi; Di is the scheduled travel distance (km) of the waiting-for-charging EVi; and FEi is the energy consumption rate (energy consumption efficiency kWh/km).

The waiting-for-charging EV cars are divided into two groups according to the request charging amount. The first group is a group where the request charging amount of each waiting-for-charging EV car is smaller than the maximum charging amount (Emax). The second group is a group where the request charging amount of each waiting-for-charging EV car is equal to or larger than the maximum charging amount (Emax). The surplus charging amount of the first group is proportionally distributed to the waiting-for-charging EV cars of the second group. First, the surplus charging amount is calculated according to Formula (4). Herein, EVw is the group of waiting-for-charging EV cars.

$$Surplus Charging Amount \text{:} {E}_{s} = {\sum }_{i ε EVw} max ( 0 , E {max}_{i} - {ED}_{i} ) \qquad ( 4 )$$

Next, the supply charging amount to each waiting-for-charging EV car is calculated by proportionally distributing to the waiting-for-charging EV cars of the second group, and calculated according to Formula (5).

$$Supply Charging Amount \text{:} {E}_{as , i} = min ( {Ed}_{j} , E {max}_{j} + \frac{{E}_{s} \times max ( 0 , {Ed}_{i} - E {max}_{i} )}{{\sum }_{i ε EVw} max ( 0 , {Ed}_{i} - E {max}_{i} )} ) \qquad ( 5 )$$

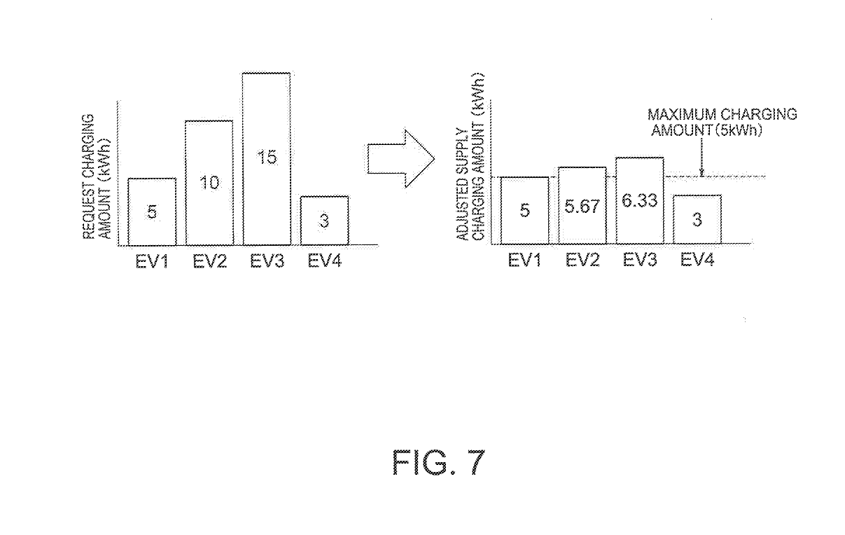

FIG. 7 is a diagram illustrating charging amount adjustment performed by the charging amount adjustment unit 9. In this example, the request charging amounts of the EV car 1, the EV car 2, the EV car 3, and the EV car 4 are 5 kWh, 10 kWh, 15 kWh, and 3 kWh, respectively. By using the maximum charging amount=5 kWh calculated by the charging condition determination unit 8, the charging amount adjustment unit 9 proportionally distributes the surplus charging amount of 2 kWh (=5 kWh−3 kWh) of the EV car 4 to the EV car 2 and the EV car 3. As a result, 5.67 kWh is supplied to the EV car 2, and 6.33 kWh is supplied to the EV car 3.

Next, the charging information output by the charging information output unit 10 will be described in detail.

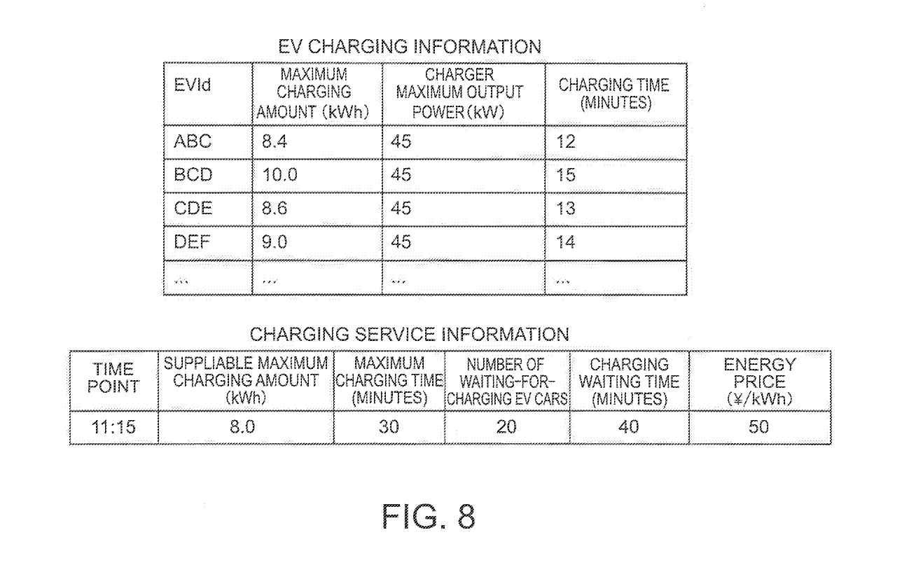

FIG. 8 is a diagram illustrating an example of the EV charging information and the charging service information output by the charging information output unit 10. The EV charging information includes an EV car Id, the maximum charging amount (kWh) of each EV car, the charger maximum output power (kW) and the charging time (minutes) at the time of charging of each EV car. The charging service information includes the time point (current time point), the suppliable maximum charging amount (kWh), the maximum charging time (minutes), the number of waiting-for-charging EV cars, the charging waiting time (minutes), and the energy price (yen/kWh).

The calculation of the charging waiting time may be performed by the charging condition determination unit 8. The charging waiting time of a newly-arriving EV car is calculated by using the maximum charging time (CTm) returned by the charging condition determination unit 8. The charging waiting time is calculated according to, for example, Formula (6).

$$\begin{matrix} [ Mathematical Formula 6 ] & \\ Charging Waiting Time of Newly \text{-} Arriving EV Car \text{:} WT = \frac{1}{{n}_{qc}} {\sum }_{i = 1}^{{N}_{w}} {CTm}_{i} + {max}_{j ∈ Nc} ( {CTr}_{i} ) & ( 6 )\end{matrix}$$

In Formula (6), Nw is the number of waiting-for-charging EV cars; CTmi is the maximum charging time of the waiting-for-charging EVi; n_{qc} is the number of chargers 18; Nc is the number of charging EV car; and the CTri is the time taken until charging completion of the charging EV car. By displaying the charging service information on an electric bulletin board or a car navigation, the charging behavior of the EV car user may be manipulated.

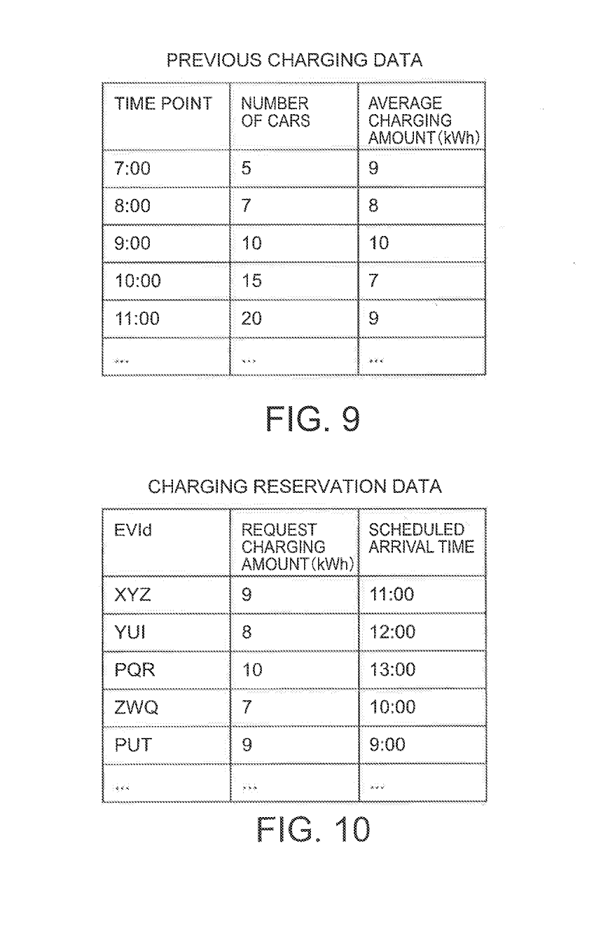

The number of scheduled-to-arrive EV cars may be estimated by using previous charging data, charging reservation data, or OD data. FIG. 9 is a diagram illustrating an example of the previous charging data. By using the data, the number of EV cars and the charging amount demand within a time period of interest may be estimated.

FIG. 10 is a diagram Illustrating an example of the charging reservation data. By using the data, the scheduled-to-arrive EV cars within the time period of interest may be extracted, and the number of EV cars and the charging amount demand may be estimated.

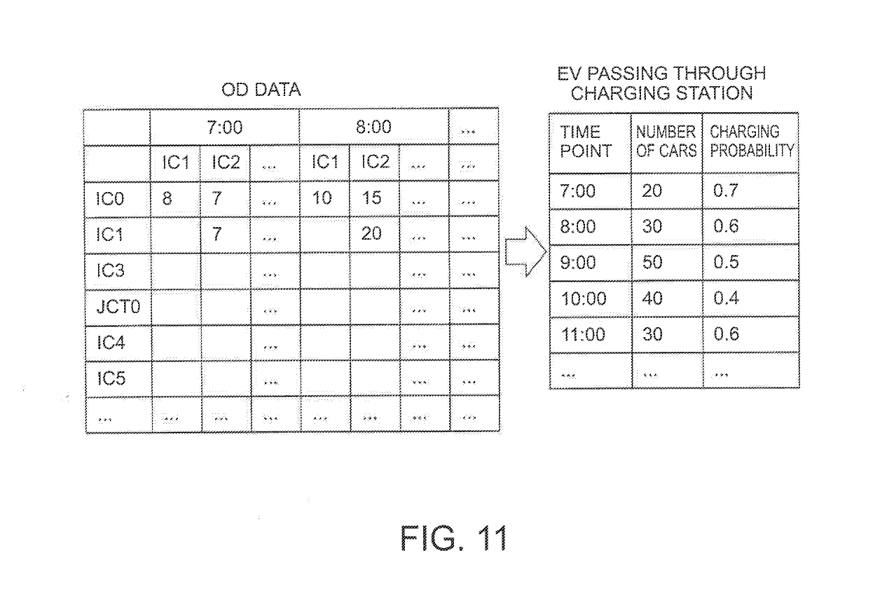

FIG. 11 illustrates an example of the OD data of the number of EV cars moving from an interchange (IC) or an interchange junction (JCT) to another interchange (IC) or another interchange junction. EV data of the EV cars passing through the charging station are calculated from the OD data.

The charging probability is calculated by using the distance from an IC or a JCT to the charging station and information about other charging stations. For example, if the distance to the charging station is 40 or more and there are two charging stations, the charging probability is set to 0.5. If there are EV data of the EV cars passing through the charging station, the number of EV cars arriving within the time period of interest is calculated according to the following Formula (7).

$$Number of Scheduled \text{-} to \text{-} Arrive Ev Cars = {\sum }_{t} {n}_{p} ( t ) \times {P}_{r} ( t ) \qquad ( 7 )$$

Herein, nₚ(t) and Pᵣ(t) are the number of EV cars passing at the time point t and the charging probability, respectively.

In this way, in the first embodiment, by taking into consideration the number of waiting-for-charging EV cars and the number of scheduled-to-arrive EV cars, the preliminary charging amount which can be supplied to each EV car is calculated and the maximum charging amount of each EV car is obtained by using the EV charging model. In the first embodiment, the desirable charging condition is searched and found so that the charging time is reduced as much as possible and the maximum charging amount of each EV car is increased as much as possible, while satisfying a predetermined constraint condition, thereby reducing the number of waiting-for-charging EV cars and balancing the supply power from the system power.

### Second Embodiment

A second embodiment has a feature in the maximum charging amount calculation method in which the total amount of the necessary charging amounts of waiting-for-charging EV cars is larger than the total amount of the preliminary charging amounts calculated by the preliminary charging amount calculation unit 6.

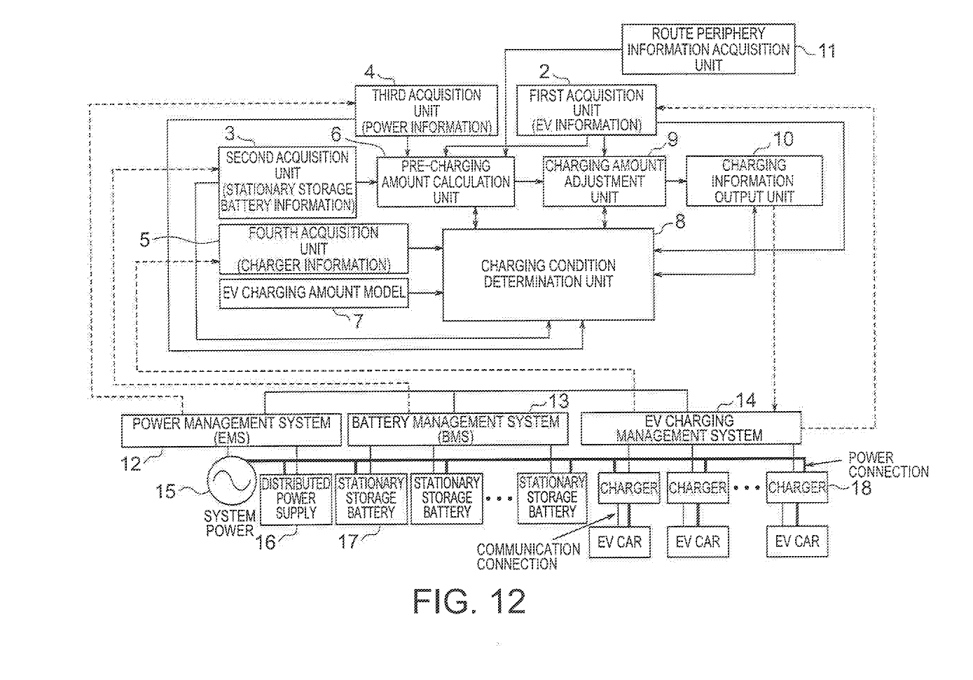

FIG. 12 is a block diagram illustrating a schematic configuration of a charging management device 1 according to the second embodiment. The charging management device 1 of FIG. 12 includes a route periphery information acquisition unit 11 in addition to the configuration of FIG. 1. The route periphery information acquisition unit 11 acquires the travel route information of each EV car and the charging site information of the charging sites existing in the periphery of the charging station.

The preliminary charging amount calculation unit 6 according to the second embodiment calculates the necessary charging amount of the waiting-for-charging EV car by using the information acquired by the route periphery information acquisition unit 11. In a case where the travel route of the waiting-for-charging EV car is known, if there is another charging site during the travel along the travel route to the destination, the preliminary charging amount calculation unit 6 calculates energy necessary for traveling to the charging site. In a case where there is no other charging site during the travel along the travel route to the destination, the preliminary charging amount calculation unit 6 calculates energy necessary for traveling to the destination. Next, the preliminary charging amount calculation unit 6 calculates the necessary charging amount of the waiting-for-charging EV car by subtracting the battery residual amount of the waiting-for-charging EV car from the calculated energy. If the battery residual amount of the waiting-for-charging EV car cannot be acquired, the preliminary charging amount calculation unit 6 assumes the battery residual amount of the waiting-for-charging EV car as a lower limit value, for example, 10% of SOC. In addition, in a case where the travel route of the waiting-for-charging EV car is unknown, the preliminary charging amount calculation unit 6 calculates the energy necessary for moving to the furthest charging site among the other charging sites in the periphery of the charging station, for example, energy necessary for moving to a radius of km.

Next, the preliminary charging amount calculation unit 6 calculates the preliminary charging amount of each EV car of the scheduled-to-arrive EV group by subtracting the total amount of the necessary charging amounts of the waiting-for-charging EV group from the available energy. After that, the charging condition determination unit 8 calculates the maximum charging amount, the charger maximum output power, and the maximum charging time of each EV car of the waiting-for-charging EV group and the scheduled-to-arrive EV group.

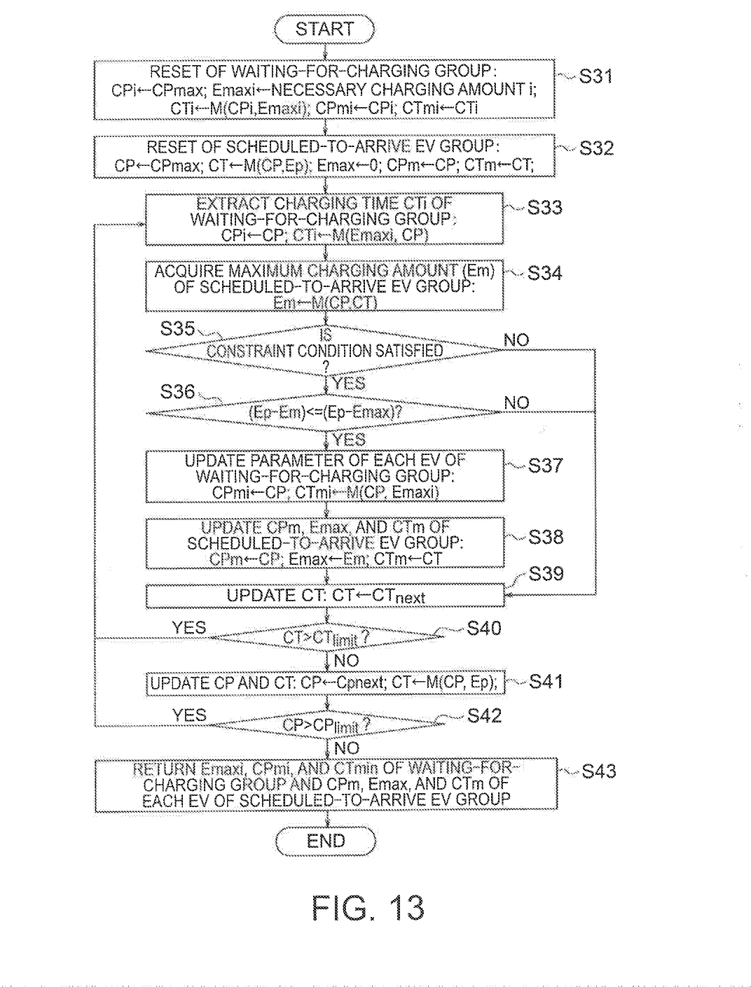

FIG. 13 is a flowchart illustrating process operations of the charging condition determination unit 8 according to the second embodiment. Although FIG. 13 illustrates the process operations of the charging condition determination unit 8 using the maximum charging amount closest to the preliminary charging amount as an evaluation criterion, as described in FIG. 5, other evaluation items may be used. In the start of the flowchart of FIG. 13, for each EV car of the waiting-for-charging EV group, without changing the necessary charging amount, the maximum output power of the charger 18 and the maximum charging time of the EV car are calculated. In addition, for each EV car of the scheduled-to-arrive EV group, the maximum charging amount, the charger maximum output power, and the maximum charging time are calculated.

First, the charging condition determination unit 8 resets each of EV parameters, for example, the charging time variable (CTi), the charger maximum output power variable (CPi), the maximum charging amount (Emaxi), the charger maximum output power (CPmi), and the maximum charging time (CTmi) of the waiting-for-charging EV group (step S31). The maximum charging amount (Emaxi) is reset to the necessary charging amount.

Next, the charging time variable (CT), the charger maximum output power variable (CP), the maximum charging amount (Emax), the charger maximum output power (CPm), and the charging time (CTm) of each EV car of the scheduled-to-arrive EV group are reset (step S32). The charger maximum output power variable (CP) is reset to the maximum value of the charger output of the EV charging model, for example, 50 (kW).

In step S32, the charging time corresponding to the charger maximum output power variable CP and the preliminary charging amount Ep are acquired by using the EV charging model M and are set to the charging time variable (CT). This process is represented by CT←M (CP, Ep). The charging time variable (CT) may be reset to the maximum value of the charging time of the EV charging model M, for example, 30 minutes. The maximum charging amount (Emax) is reset to the preliminary charging amount Ep. The maximum charging amount (Emax), the charger maximum output power (CPm), and the maximum charging time (CTm) are reset to 0, CP, and CT, respectively.

Next, the charging time CTi is extracted according to the maximum charging amount (Emaxi) and charger maximum output power (CPmi) for each EV car of the waiting-for-charging group by using the EV charging model M (step S33). This process is represented by CPI←CP and CTi←M (Emaxi, CP).

Next, the maximum charging amount (Em) is obtained according to the CP and the CT for each EV car of the scheduled-to-arrive EV group by using the EV charging model (step S34). This process is represented by Em←M (CP, CT). Herein, the M is the EV charging model.

Next, it is checked whether or not a constraint condition is satisfied (step S35). The constraint condition is, for example, at least one of the previously-described conditions 1 to 3.

If the constraint condition is satisfied, it is checked whether or not the maximum charging amount (Em) is closer to the Ep than to the Emax (step S36). If the Em is closer to the Ep than to the Emax, parameters of each EV car of the waiting-for-charging group are updated (step S37). This process is represented by CPmi←CP and CTmi←M (CP, Emaxi).

Next, the charger maximum output power and the maximum charging amount of each EV car of the scheduled-to-arrive EV group are updated (step S38). This process is represented by CPm←CP, Emax←Em, and CTm←CT.

If the constraint condition is not satisfied, or if the maximum charging amount (Em) is not close to the Ep, the charging time is updated (step S39). This process is represented by CT←CTnext. Herein, the CTnext is the next charging time of the EV charging model table.

After that, it is checked whether or not the charging time variable (CT) is larger than the lower limit value (step S40), and if larger, the process returns to step S33. If the CT is equal to or smaller than the lower limit value, the charger maximum output power variable (CP) and the charging time variable (CT) are updated (step S41). This process is represented by CP←CPnext and CT←M (CP, Ep). Here, the CPnext the next charger maximum output power of the EV charging model table.

Next, it is checked whether or not the charger maximum output power variable (CP) is larger than the lower limit value (step S42). If larger, the process returns to step S33. If not larger, the maximum charging amount (Emaxi), the charger maximum output power (CPmi), and the charging time (CTmi) of each EV car of the waiting-for-charging group and the charger maximum output power (CPm), the maximum charging amount (Emax), and the charging time (CTm) of each EV car of the scheduled-to-arrive EV group are output (step S43).

In a case where the total amount of the necessary charging amounts of the waiting-for-charging EV cars is larger than the total amount of the preliminary charging amounts calculated by the preliminary charging amount calculation unit 6, the adjustment of the maximum charging amount is not performed.

In this way, in the second embodiment, the necessary charging amount required for traveling to the charging station along the travel route of the waiting-for-charging EV car is calculated, and the preliminary charging amount is calculated by using this necessary charging amount. Therefore, the problem that the battery exhaustion may occur during the travel of the waiting-for-charging EV car to the destination disappears. In addition, since the charging condition determination unit 8 performs processes separately with respect to the waiting-for-charging group configured with the waiting-for-charging EV cars, and the scheduled-to-arrive group configured with the scheduled-to-arrive EV car, the charging condition suitable for the waiting-for-charging group and the charging condition suitable for the scheduled-to-arrive group can be set.

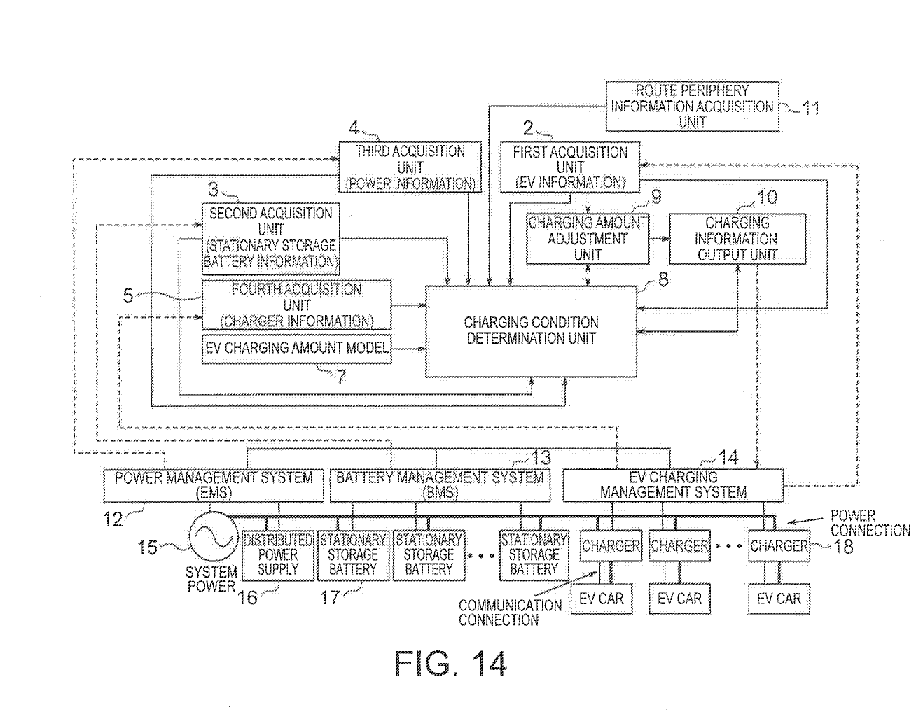

The processes of the preliminary charging amount calculation unit 6 in the above-described first and second embodiment may be performed by the charging condition determination unit 8. In this case, as illustrated in the block diagram of FIG. 14, the preliminary charging amount calculation unit 6 is unnecessary.

### Third Embodiment

Although FIGS. 3 and 4 illustrate the examples of the EV charging model outputting the charging amount of the EV car based on the input parameters such as the charging time or the maximum output power of the charger 18, a stationary storage battery discharging model outputting the necessary discharging amount from the stationary storage battery 17 based on the input parameters may be provided in addition to the EV charging model.

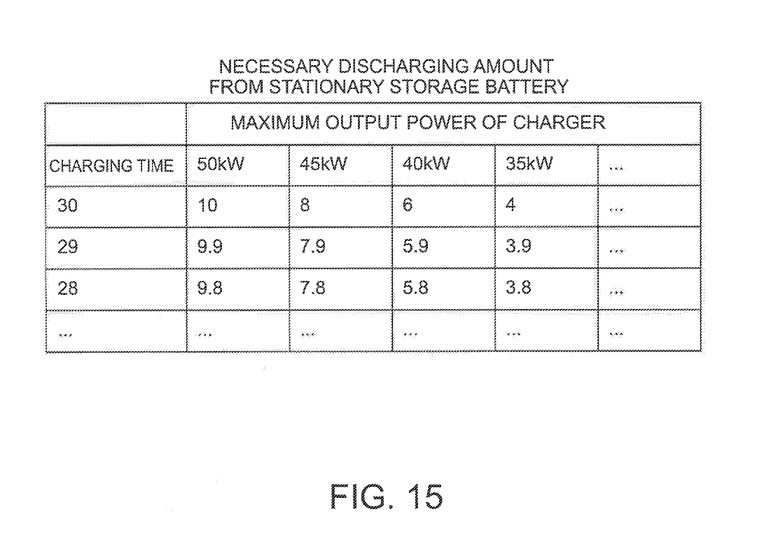

FIG. 15 is an example of the stationary storage battery discharging model. Similarly to FIG. 3, the table of FIG. 15 outputs the necessary discharging amount from the stationary storage battery 17 by using the charging time of the EV car and the maximum output power of the charger 18 as input parameters. The stationary storage battery discharging model is provided as a stationary storage battery discharging model storage (not illustrated) in the charging management device 1.

The stationary storage battery discharging model is provided in addition to the EV charging model illustrated in FIG. 3 or 4, so that charging control of each EV car can be performed by more efficiently using the stationary storage battery 17.

### Fourth Embodiment

In a fourth embodiment described below, an upper-level EMS managing a plurality of charging stations is provided.

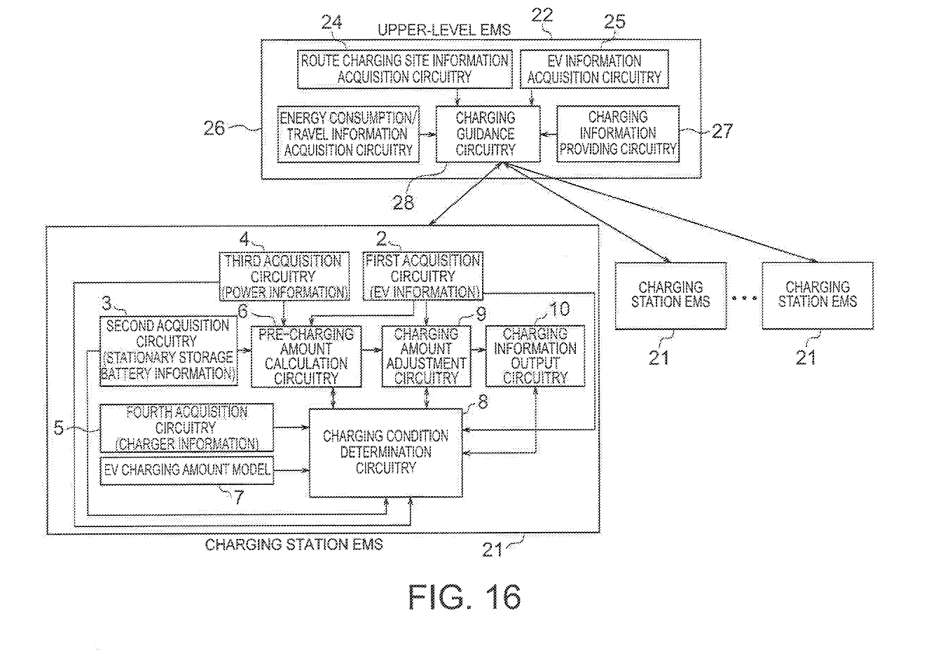

FIG. 16 is a block diagram illustrating a schematic configuration of a charging management system 23 including a plurality of charging stations 21, each of which includes the charging management device 1 described in the first to third embodiment and an upper-level EMS 22 which manages the charging stations 21.

The upper-level EMS 22 determines the charging station 21 at which is to charge each EV car which travels in the periphery of the plurality of charging stations 21 and manages the charging amount in the determined charging station 21.

The upper-level EMS 22 is configured to include a route charging site information acquisition unit (route charging site information acquisition circuitry) 24, an EV information acquisition unit (EV information acquisition circuitry) 25, and an energy consumption/travel information acquisition unit (energy consumption/travel information acquisition circuitry) 26, and a charging information providing unit (charging information providing circuitry) 27, and a charging guidance unit (charging guidance circuitry) 28.

The route charging site information acquisition unit 24 acquires and stores road information or information on charging sites. The EV information acquisition unit 25 acquires and stores the EV information about the waiting-for-charging EV cars and the scheduled-to-arrive EV cars. The energy consumption/travel information acquisition unit 26 acquires and stores average energy consumption rate and travel route information of each EV car. The charging information providing unit 27 provides the charging information. The charging guidance unit 28 determines the charging site of each EV car.

Each of the plurality of charging stations 21 calculates the suppliable maximum charging amount, the maximum charging time, and the maximum output power of the charger 18 based on the information on the charging EV cars and the waiting-for-charging EV cars and transmits the charging information to the upper-level EMS 22.

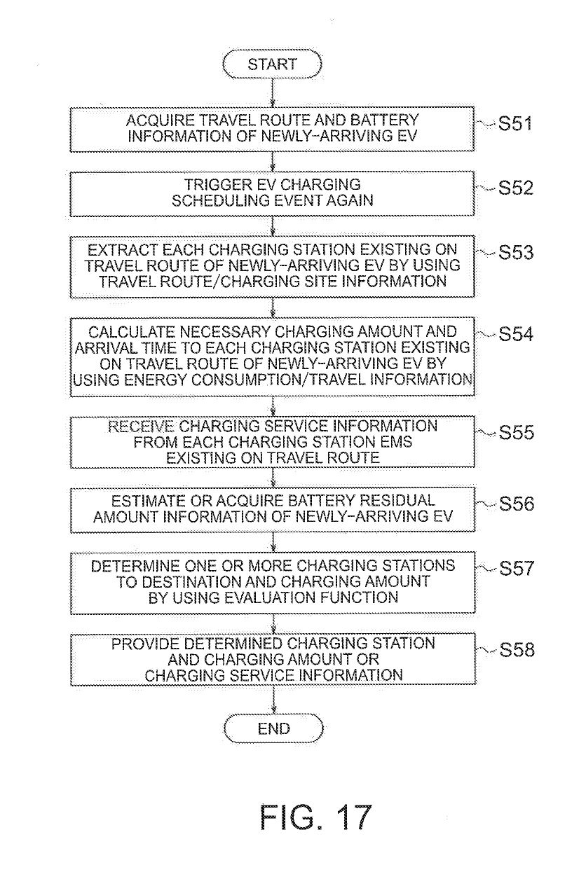

FIG. 17 is a flowchart illustrating process operations of the upper-level EMS 22 according to the fourth embodiment. First, the charging guidance unit 28 of the upper-level EMS 22 acquires the travel route and the battery information of an EV car which newly arrives in a charging station 21 (step S51, fifth acquisition unit or fifth acquisition circuitry). Next, the charging guidance unit 28 starts an EV charging scheduling event again (step S52).

First, the charging guidance unit 28 extracts each charging station 21 along the travel route of the newly-arriving EV car by using the route/charging site information from the route charging site information acquisition unit 24 (step S53, extraction unit or extraction circuitry), calculates the necessary charging amount required to reach each extracted charging station 21 and the arrival time (step S54, charging condition calculation unit or charging condition calculation circuitry), and acquires the charging service information from the EMS of each charging station 21 along the travel route (step S55, sixth acquisition unit or sixth acquisition circuitry).

Next, the battery residual amount information of the newly-arriving EV car is assumed or acquired (step S56, seventh acquisition unit or seventh acquisition circuitry), one or more charging stations 21 until destination and the charging amounts are determined so that charging waiting time is reduced, the charging load of the electric vehicles exerted on the power system is balanced, or running out of energy is avoided (step S57, EMS determination unit or EMS determination circuitry).

The upper-level EMS 22 provides the charging station 21 and the charging amount, determined by the charging guidance unit 28, to the newly-arriving EV car. Since the charging information cannot be acquired from all the EV cars, the charging guidance unit 28 of the upper-level EMS 22 collects the charging service information from the EMS of each charging station 21 at regular intervals and provides the charging information through the charging information output unit 10 (step S58). The charging information output unit 10 displays the information on a car navigation, the Internet, an ITS (Intelligent Transportation System) spot, or an electric bulletin board.

Next, a method of determining the charging station 21 and the charging amount is described. In the case of selecting one charging station 21, a first charging station group along the travel route which can be reached by using the battery residual amount information of the newly-arriving EV car is determined. Next, the necessary charging amount required from the current position to the destination is calculated. Next, a second charging station group satisfying the following condition is determined. In this case, the following Formula (8) is allowed to be satisfied.

Suppliable Charging Amount+Battery Residual Amount of Newly-Arriving EV Car−Necessary Charging Amount Required from Current Position to Destination>0 (8)

At the time of determining the second charging station group, upper and lower limit values of the battery residual amount of the newly-arriving EV car may be considered. In this case, the necessary charging amount required from the current position to each charging station 21 of the first charging station group and the necessary charging amount required from the charging station 21 to the destination are calculated. Next, the second charging station group satisfying both of the following conditions 1 and 2 is determined.

1. (Battery Residual Amount of Newly-Arriving EV Car−(Necessary Charging Amount Required from Current Position to Charging station 21)≧Lower Limit Value of Battery Residual Amount of Newly-Arriving EV Car.

2. (Min (Upper Limit Value of Battery Residual Amount of Newly-Arriving EV Car, Battery Residual Amount of Newly-Arriving EV Car−Necessary Charging Amount Required From Current Position to Charging Station 21+Suppliable Charging Amount)−Necessary Charging Amount Required from Charging Station 21 to Destination)≧Lower Limit Value of Battery Residual Amount of Newly-Arriving EV Car.

Finally, the charging station 21 having the shortest charging waiting time is determined from the second charging station group.

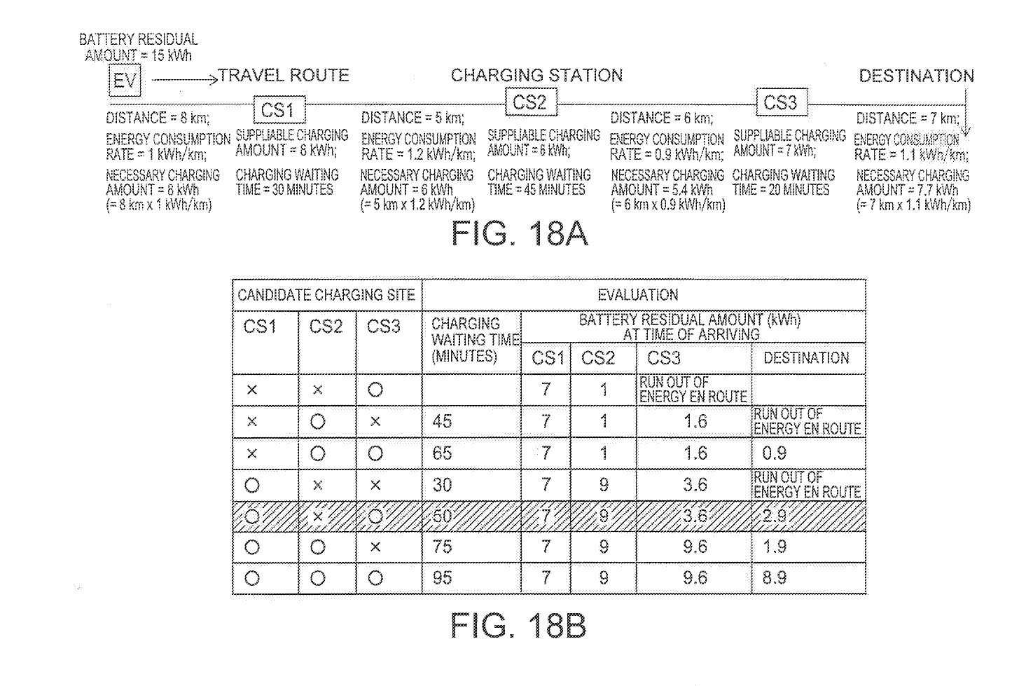

FIG. 18 is a diagram illustrating a method of determining a plurality of charging stations 21 and charging amounts. In a case where the number of candidate charging stations 21 is small, this method is very useful. First, a candidate charging site list is produced by combining the charging stations 21 along the travel route. In a case where there are n candidate charging stations 21, the number of candidate charging sites is 2ⁿ−1. In the example of FIG. 18A, since, there are three candidate charging stations 21, the number of combinations of the candidate charging sites is 2³−1=7. Therefore, as illustrated in FIG. 18B, seven combinations are listed in the candidate charging site list. The candidate charging site list of FIG. 18B illustrates that the charging stations 21 designated with O are selected, and the charging of the newly-arriving EV car is performed with the charging amount which can be supplied from the charging stations 21.

Next, each candidate charging site is evaluated by using an evaluation function. As an evaluation function, the charging waiting time and the battery residual amount of the newly-arriving EV car at the time of arriving at each candidate charging station 21 and the destination are used as an evaluation function. In each candidate charging station 21 selected as a candidate charging site, the newly-arriving EV car is charged with a suppliable charging amount. The battery residual amount of the newly-arriving EV car at the time of arriving at each candidate charging station 21 or the destination is calculated according to the following Formula (9). In Formula (9), the candidate charging station 21 or the destination is set as an arrival site i.

Battery Residual Amount at Time of Arriving at Arrival Site i=Battery Residual Amount at Current Position+Σₖ·δₖ×Suppliable Charging Amount at Charging Station 21k−Necessary Charging Amount Required up to Arrival Site i (9)

Herein, k=1, 2, . . . , i−1, δkε{0, 1}, and in a case where a charging station k is selected among the candidate charging sites (O in FIG. 18), δk becomes 1.

Finally, the candidate charging site having the best value of the evaluation function, for example, the minimum charging waiting time is extracted from the candidate charging sites. In this example, the candidate charging site containing CS1 and the CS3 is selected; charging of 8 kWh is performed at the CS1 and charging of 7 kWh is performed at the CS3; and the charging waiting time is 50 minutes.

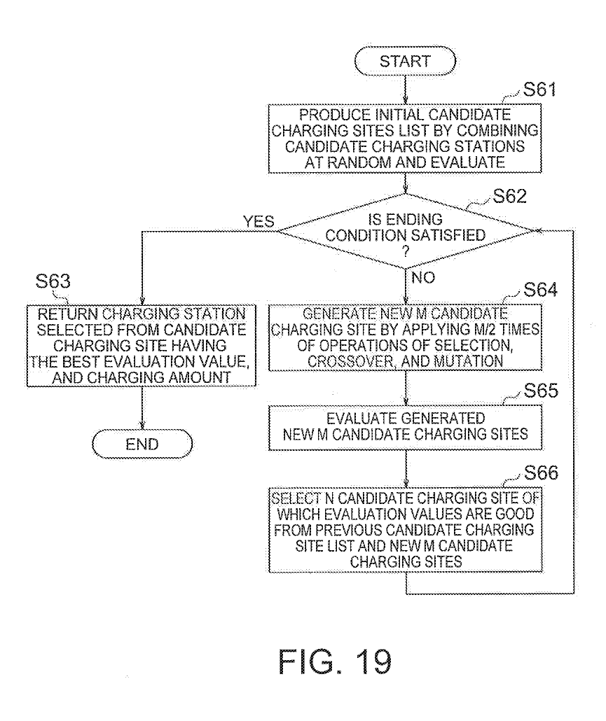

In a case where there are a large number of candidate charging stations 21, a global optimization technique, such as a genetic algorithm (GA) may be used to determine a plurality of the charging stations 21 and the charging amounts. FIG. 19 is a flowchart illustrating an example of determining a plurality of the charging stations 21 and the charging amounts by using a genetic algorithm. The flowchart corresponds to the process of step S57 of FIG. 17.

First, the candidate charging sites are encoded as binary numbers. In a case where there is 1 in the candidate charging site, the corresponding charging station 21 is selected, and the charging of the newly-arriving EV car is performed with the charging amount which can be supplied by the charging station 21. In a case where there is 0 in the candidate charging site, charging is not performed in the corresponding charging station 21. Next, an initial candidate charging site list is produced by combining the charging stations 21 at random, and the evaluation is performed (step S61). As an evaluation function, the charging waiting time or a possibility of running out of energy en route to the destination, or the number of times of charging is used.

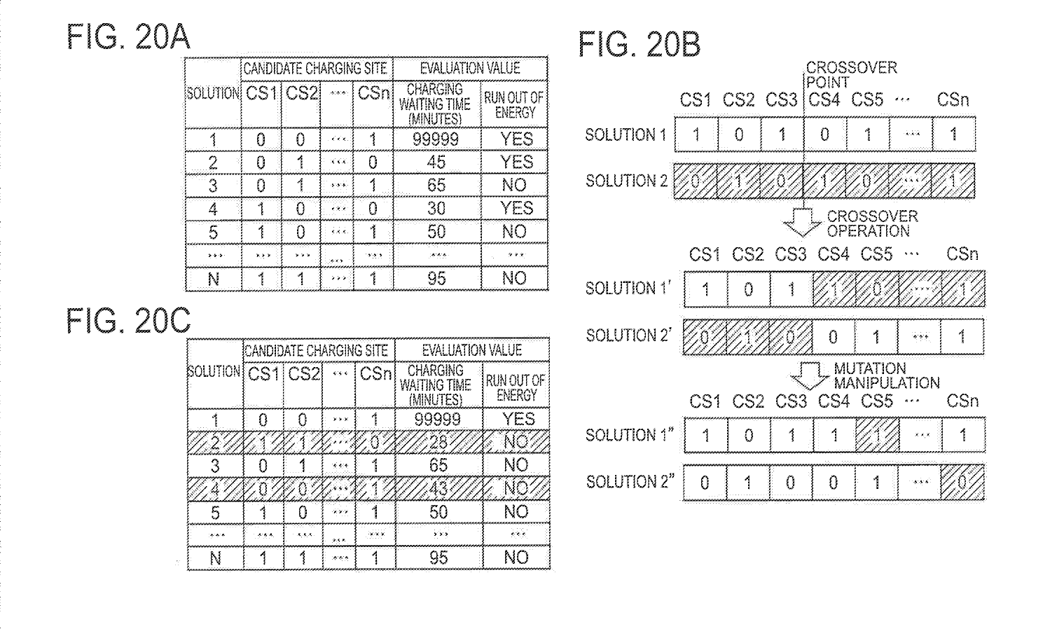

FIG. 20A is a diagram illustrating an example of an initial candidate charging site list. In the list, “1” denotes a candidate charging site. The charging waiting time of “99999” denotes the case where a candidate charging site includes a charging station after run out of energy en route to that charging station.

Next, it is checked whether or not an ending condition is satisfied (step S62). As an ending condition, the maximum number of times of repetition, a lower limit value of the battery residual amount of the newly-arriving EV car at the time of arriving at the destination, the number of times of charging, the charging waiting time, or the like is used. If the ending condition is satisfied, the charging stations 21 selected in the candidate charging site having the best evaluation value, and the charging amount are returned (step S63). The case where the evaluation value is the best is a case where the charging waiting time and the number of times of charging are the lowest without having run out of energy.

If the ending condition is not satisfied, new M candidate charging sites are generated by applying M/2 times of operations of selection, crossover, or mutation in the previous candidate charging site list (step S64).

FIG. 20B illustrates an example of generating new candidate charging sites by applying the operations of crossover and mutation in step S64. In this example, the operations are performed in the order of selection, crossover, and mutation.

Next, the generated new M candidate charging sites are evaluated by using the previously used evaluation function (step S65). Next, from the previous candidate charging site list and the new M candidate charging sites, the N candidate charging sites having good evaluation values are selected (step S66).

FIG. 20C is a diagram illustrating an example of an N candidate charging sites list having good evaluation values. It can be understood that the charging waiting time in the solution 2 is shorter than that of FIG. 20A.

After that, returning to step S62, it is checked whether or not the ending condition is satisfied again.

In this way, in the fourth embodiment, the upper-level EMS 22 managing a plurality of charging stations is provided and, the information such as the site of the charging station 21 where the charging is to be performed next and the charging amount is provided to the EV car based on the information about the travel route of the EV car arriving at one of the charging stations 21, and the EV information. Therefore, each EV car does not need to perform searching for a good charging station 21 by itself during travel to the destination, resulting in improved convenience. At least a portion of the charging management devices and the charging management systems described in the above embodiments may be configured by hardware or may be configured by software. In the case of configuring by software, programs of embodying at least a portion of the functions of the charging management devices and the charging management systems may be stored in a recording medium such as a flexible disk or a CD-ROM, and a computer may be allowed to read and execute the programs. The recording medium is not limited to a detachable one such as a magnetic disk or an optical disk, but a fixed recording medium such as a hard disk device or a memory may be employed.

In addition, the programs of embodying at least a portion of the functions of the charging management devices and the charging management systems may be delivered via a communication line (including wireless communication) such as the Internet. In addition, encryption, modification, or compression of the program may be distributed via a wired line or a wireless line such as the Internet or in a form of being stored in a recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A charging management device comprising:
a first acquisition circuitry which acquires EV information necessary to charge each EV car in a charging station;
a second acquisition circuitry which acquires stationary storage battery information including a maximum output power of a stationary storage battery provided in the charging station;
a third acquisition circuitry which acquires supply power information from a system power which can be used to charge each EV car in the charging station;
a fourth acquisition circuitry which acquires charger information including a maximum output power of a charger provided in the charging station;
a preliminary charging amount calculation circuitry which calculates a preliminary charging amount representing a charging amount of each EV car which can be charged in the charging station based on the information acquired by the first to fourth acquisition circuitries;
an EV charging model storage circuitry which stores an EV charging model outputting a maximum charging amount of the EV car by using the maximum output power of the charger and a charging time of the EV car as input parameters; and
a charging condition determination circuitry which, after a certain constraint condition is satisfied, determines a charging condition that the charging time of each EV car and the maximum output power of the charger are within certain ranges, respectively, and the difference between the maximum charging amount of each EV car and the preliminary charging amount is further reduced.

2. The charging management device according to claim 1, further comprising a charging amount adjustment circuitry which adjusts the maximum charging amount of each EV car determined by the charging condition determination circuitry based on at least one of a request charging amount and a battery residual amount of each waiting-for-charging EV car.

3. The charging management device according to claim 2, wherein the charging amount adjustment circuitry adjusts the maximum charging amount of each EV car by proportionally distributing a surplus charging amount exceeding the request charging amount among the maximum charging amounts of the EV cars determined by the charging condition determination circuitry, to the EV cars of which charging amounts do not exceed the request charging amount.

4. The charging management device according to claim 1, wherein the constraint condition includes at least one of a constraint condition associated with a request charging time requested by each EV car, a constraint condition associated with a request discharging power requested from the stationary storage battery, a constraint condition associated with a request discharging amount requested from the stationary storage battery, and a constraint condition associated with a charging waiting time of each EV car.

5. The charging management device according to claim 1, wherein the EV charging model outputs the maximum charging amount of the EV car by using the maximum output power of the charger, the charging time of the EV car, information on a battery of the EV car, and a battery residual amount of the EV car as input parameters.

6. The charging management device according to claim 1, further comprising a stationary storage battery discharging model storage which stores a stationary storage battery discharging model which outputs the maximum charging amount of the EV car and a necessary discharging amount of the stationary storage battery by using the maximum output power of the charger and the charging time of the EV car as input parameters,
wherein the charging condition determination circuitry determines the charging condition based on the EV charging model, the stationary storage battery discharging model and the preliminary charging amount so that the constraint condition is satisfied.

7. The charging management device according to claim 1, wherein the charging condition determination circuitry comprises:
a first check circuitry which acquires the maximum charging amount of the EV car corresponding to the set input parameters from the EV charging model and checks whether or not the constraint condition is satisfied;
a second check circuitry which checks whether or not the maximum charging amount acquired from the EV charging model is closer to the preliminary charging amount than to a set-in-advance maximum charging amount in a case where the constraint condition is satisfied;
a parameter update circuitry which updates the maximum charging amount and the charging time of the EV car and the maximum output power of the charger based on the input parameters in a case where the maximum charging amount acquired from the EV charging model is closer to the preliminary charging amount;
a third check circuitry which checks whether or not the charging time of the EV car included in the newly-selected input parameters is smaller than a previously-defined first lower limit value in a case where the set-in-advance maximum charging amount is closer to the preliminary charging amount or in a case where the update by the parameter update circuitry is ended; and
a fourth check circuitry which performs the check of the first check circuitry again in a case where the charging time is not smaller than the first lower limit value and checks whether or not the maximum charging amount of the EV car included in the newly-selected input parameters is smaller than a set-in-advance second lower limit value in a case where the charging time is smaller than the first lower limit value,
wherein, in a case where the charging time is not smaller than the second lower limit value, the check of the first check circuitry is performed again, and in a case where the charging time is smaller than the second lower limit value, the charging condition including the maximum charging amount and the charging time of the EV car lastly updated by the parameter update circuitry and the maximum output power of the charger is determined.

8. The charging management device according to claim 1, wherein the charging condition determination circuitry determines the maximum charging amount of each EV car of a waiting-for-charging group including one or more waiting-for-charging EV cars in the charging station and the maximum output power of the charger and determines the maximum charging amount and the charging time of each EV car of a scheduled-to-arrive group including one or more scheduled-to-arrive EV cars in the charging station and the maximum output power of the charger.

9. The charging management device according to claim 1, further comprising a route periphery information acquisition circuitry which acquires travel route information of each EV car and charging site information about charging sites existing in the periphery of the charging station,
wherein the preliminary charging amount calculation circuitry calculates necessary charging amounts of waiting-for-charging EV cars and scheduled-to-arrive EV cars based on the travel route information and the charging site information and calculates the preliminary charging amounts of the waiting-for-charging EV cars and scheduled-to-arrive EV cars by taking into consideration the necessary charging amounts.

10. The charging management device according to claim 9, wherein, in a case where the next travel route of the waiting-for-charging EV car in the charging station is unclear, the preliminary charging amount calculation circuitry calculates the necessary charging amount based on the energy necessary for the EV car traveling to the farthest charging site among the charging sites existing in the periphery of the charging station.

11. The charging management device according to claim 9, wherein, in a case where the battery residual amount of the waiting-for-charging EV car cannot be acquired, the preliminary charging amount calculation circuitry sets the battery residual amount of the EV car as a lower limit value and calculates the necessary charging amount.

12. The charging management device according to claim 1, wherein the preliminary charging amount calculation circuitry applies a weighting factor to each EV car and calculates the preliminary charging amount based on at least one of the battery residual amount of the waiting-for-charging EV car, a vehicle type of the EV car, and existence or non-existence of previous charging reservation.

13. The charging management device according to claim 1, further comprising a charging information output circuitry which provides charging information including a suppliable maximum charging amount and a maximum charging time, and charging service information including at least one of the number of waiting-for-charging EV cars, a charging waiting time, and an energy price to an EV car which newly arrives in the charging station.

14. The charging management device according to claim 13, wherein the charging information output circuitry provides the charging information to at least one of a display device provided in the charging station and an internal display circuitry of the EV car.

15. The charging management device according to claim 1, wherein in the case of the charging EV car, the EV information includes at least one of a time taken up to charging completion and a remaining supply charging amount; in the case of the waiting-for-charging EV car, the EV information includes at least one of the number of EV cars, a battery residual amount, and an EV type; and in the case of the scheduled-to-arrive EV car, the EV information includes the number of EV cars.

16. A charging management system comprising:
a plurality of charging stations, each of which comprising a charger and a stationary storage battery to perform charging of EV cars; and
a management circuitry which determines a charging station at which is to charge each EV car traveling in the periphery of the plurality of charging stations and manages a charging amount in the determined charging station;
wherein each of the plurality of charging stations comprises:
a first acquisition circuitry which acquires EV information necessary to charge each EV car in the charging station;
a second acquisition circuitry which acquires stationary storage battery information including a maximum output power of the stationary storage battery provided in the charging station;
a third acquisition circuitry which acquires supply power information from a system which can be used to charge each EV car in the charging station;
a fourth acquisition circuitry which acquires charger information including a maximum output power of the charger provided in the charging station;
a preliminary charging amount calculation circuitry which calculates a preliminary charging amount representing a charging amount of each EV car which can be charged in the charging station based on the information acquired from the first to fourth acquisition circuitries;
an EV charging model storage circuitry which stores an EV charging model outputting a maximum charging amount of the EV car or a necessary discharging amount of the stationary storage battery by using the maximum output power of the charger and a charging time of the EV car as input parameters; and
a charging condition determination circuitry which, after a certain constraint condition is satisfied, determines a charging condition that the charging time of each EV car and the maximum output power of the charger are within certain respective ranges and the difference between the maximum charging amount of each EV car and the preliminary charging amount is further reduced.

17. The charging management system according to claim 16, wherein the management circuitry comprises:
a fifth acquisition circuitry which acquires a travel route of the EV car traveling in the periphery of the plurality of charging stations and the EV information of the EV car;
an extraction circuitry which extracts the charging station on the travel route of the EV car based on the travel route acquired by the fifth acquisition circuitry and sites of the plurality of charging stations;
a charging condition calculation circuitry which calculates a necessary charging amount necessary for the EV car to travel to each charging station extracted by the extraction circuitry and a traveling time;
a sixth acquisition circuitry which acquires charging service information in each charging station extracted by the extraction circuitry;
a seventh acquisition circuitry which acquires or estimates a battery residual amount of the EV car; and
an EMS determination circuitry which determines the charging station where the charging of the EV car is to be performed by using a predetermined evaluation function, the necessary charging amount and the traveling time calculated by the charging condition calculation circuitry, the charging service information acquired by the sixth acquisition circuitry, and the battery residual amount acquired or estimated by the seventh acquisition circuitry as input parameters.

18. A charging management method comprising:
acquiring EV information necessary to charge each EV car in a charging station;
acquiring stationary storage battery information including a maximum output power of a stationary storage battery provided in the charging station;
acquiring supply power information from a system power which can be used to charge each EV car in the charging station;
acquiring charger information including a maximum output power of a charger provided in the charging station;
calculating a preliminary charging amount representing a charging amount of each EV car which can be charged in the charging station based on the acquired EV information, the acquired stationary storage battery information, the acquired supply power information, and the acquired charger information;
storing an EV charging model outputting a maximum charging amount of the EV car by using the maximum output power of the charger and a charging time of the EV car as input parameters; and
after a certain constraint condition being satisfied, determining a charging condition that the charging time of each EV car and the maximum output power of the charger are within certain ranges, respectively, and the difference between the maximum charging amount of each EV car and the preliminary charging amount is further reduced.
